(19) United States
(12) Patent Application Publication
(10) Pub. No.: US 2026/0128792 A1
(43) Pub. Date: May 7, 2026

(54) SIGNAL PROCESSING DEVICE, SIGNAL PROCESSING METHOD, AND NON-TRANSITORY COMPUTER-READABLE MEDIUM

(71) Applicant: NEC Corporation, Tokyo (JP)

(72) Inventor: Hironori NAKANISHI, Tokyo (JP)

(73) Assignee: NEC Corporation, Tokyo (JP)

(21) Appl. No.: 19/358,740

(22) Filed: Oct. 15, 2025

(30) Foreign Application Priority Data
Nov. 7, 2024 (JP) 2024-194857

(51) Int. Cl. H04B 10/25

(52) U.S. Cl. CPC H04B 10/25

(57) ABSTRACT

A signal processing device includes a supply unit that supplies identical clocks to a plurality of ADCs in a case where a plurality of signals input to the plurality of ADCs are not identical to each other, and supplies non-identical clocks to the plurality of ADCs in a case where the plurality of signals are identical to each other, and an average value output unit that outputs an average value of a plurality of digital values output from one ADC that is each of a plurality of the ADCs as a first average value in a case where the plurality of signals are not identical to each other, and outputs an average value of the first average values in the plurality of the ADCs as a second average value in a case where the plurality of signals are identical to each other.

### INCORPORATION BY REFERENCE

This application is based upon and claims the benefit of priority from Japanese patent application No. 2024-194857, filed on November 7, 2024, the disclosure of which is incorporated herein in its entirety by reference.

### TECHNICAL FIELD

The present disclosure relates to a signal processing device, a signal processing method, and a program.

### BACKGROUND ART

WO 2024/135107 A1 discloses a technique for reducing crosstalk between cores of an optical fiber by using a multiple-input multiple-output (MIMO) technique.

### SUMMARY

The MIMO preprocessing includes average value calculation processing of calculating an average value of data received via an optical fiber for each channel. In a case where the number of channels of a second optical fiber is smaller than the number of channels of a first optical fiber and the average value calculation units as many as the number of channels of the first optical fiber are used, the throughput of the average value calculation processing of data transmitted via the second optical fiber decreases.

The present disclosure has been made to solve such a problem, and an example object thereof is to provide a signal processing device, a signal processing method, and a program that suppress a decrease in throughput in average value calculation processing of calculating an average value of data transmitted by an optical fiber for each channel.

A signal processing device according to an example aspect of the present disclosure includes:

a supply unit that supplies identical clocks to a plurality of analog-to-digital converters (ADCs) in a case where a plurality of signals input to the plurality of ADCs are not identical to each other, and supplies non-identical clocks to the plurality of ADCs in a case where the plurality of signals are identical to each other; and

an average value output unit that outputs an average value of a plurality of digital values output from one ADC that is each of a plurality of the ADCs as a first average value in a case where the plurality of signals are not identical to each other, and outputs an average value of the first average values in the plurality of the ADCs as a second average value in a case where the plurality of signals are identical to each other.

A signal processing method according to an example aspect of the present disclosure includes:

supplying identical clocks to a plurality of analog-to-digital converters (ADCs) in a case where a plurality of signals input to the plurality of ADCs are not identical to each other, and supplying non-identical clocks to the plurality of ADCs in a case where the plurality of signals are identical to each other; and

outputting an average value of a plurality of digital values output from one ADC that is each of a plurality of the ADCs as a first average value in a case where the plurality of signals are not identical to each other, and outputting an average value of the first average values in the plurality of the ADCs as a second average value in a case where the plurality of signals are identical to each other.

A program according to an example aspect of the present disclosure causes a computer to execute:

a process of supplying identical clocks to a plurality of analog-to-digital converters (ADCs) in a case where a plurality of signals input to the plurality of ADCs are not identical to each other, and supplying non-identical clocks to the plurality of ADCs in a case where the plurality of signals are identical to each other; and

a process of outputting an average value of a plurality of digital values output from one ADC that is each of a plurality of the ADCs as a first average value in a case where the plurality of signals are not identical to each other, and outputting an average value of the first average values in the plurality of the ADCs as a second average value in a case where the plurality of signals are identical to each other.

According to the present disclosure, it is possible to provide a signal processing device, a signal processing method, and a program that suppress a decrease in throughput in average value calculation processing of calculating an average value of data transmitted by an optical fiber for each channel.

### BRIEF DESCRIPTION OF DRAWINGS

FIG. 1 is a diagram for explaining an example of processing on data transmitted via an MCF;

FIG. 2 is a diagram for explaining an example of processing on data transmitted via an SCF;

FIG. 3 is a block diagram illustrating a configuration of a signal processing device according to the present disclosure;

FIG. 4 is a flowchart illustrating a signal processing method according to the present disclosure;

FIG. 5 is a block diagram illustrating a configuration of the signal processing device according to the present disclosure;

FIG. 6 is a diagram for explaining the operation of a MIMO preprocessing circuit according to the present disclosure;

FIG. 7 is a block diagram illustrating a configuration of the signal processing device according to the present disclosure;

FIG. 8 is a diagram for explaining DC offset processing in a case where data is transmitted via the MCF;

FIG. 9 is a diagram for explaining DC offset processing in a case where data is transmitted via the SCF;

FIG. 10 is a diagram for explaining processing of calculating a second average value in a case where the number of ADCs is 4;

FIG. 11 is a block diagram illustrating a configuration of an average value calculation unit according to the present disclosure; and

FIG. 12 is a block diagram illustrating a hardware configuration of the signal processing device according to the present disclosure.

### EXAMPLE EMBODIMENT

### Background for Achieving Example Embodiments

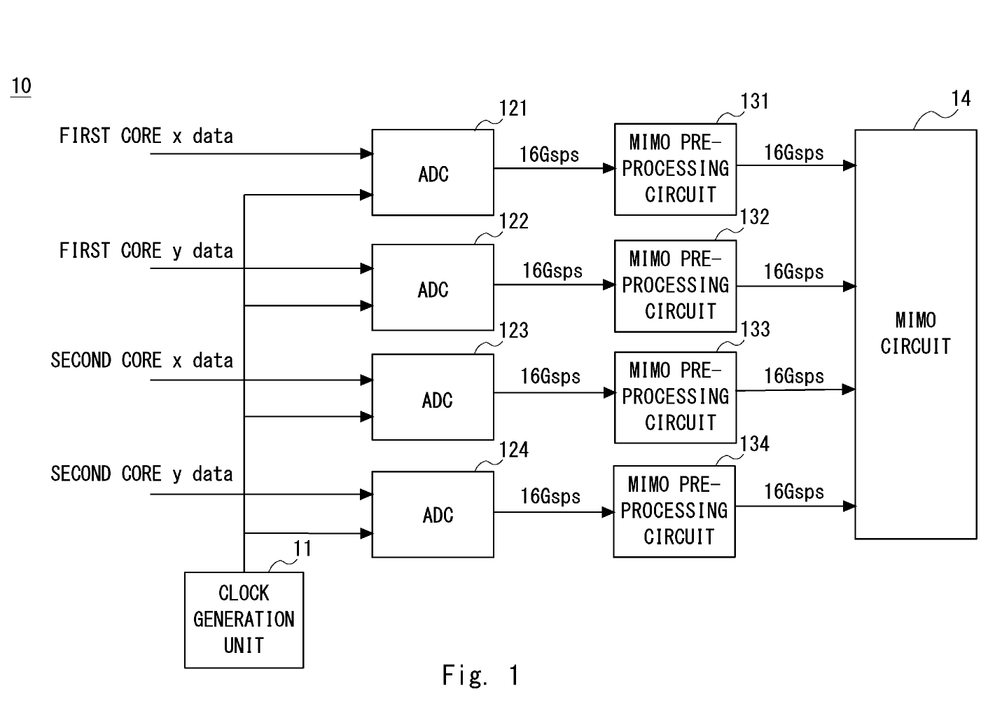

FIG. 1 is a diagram for explaining an example of processing for data transmitted via a multi core fiber (MCF). The MCF includes a first core and a second core.

A signal processing device 10 includes a clock generation unit 11, analog-to-digital converters (ADCs) 121 to 124, multiple-input multiple-output (MIMO) preprocessing circuits 131 to 134, and a MIMO circuit 14. In a case where the ADCs 121 to 124 are not distinguished from each other, they may be simply referred to as ADCs 12. In a case where the MIMO preprocessing circuits 131 to 134 are not distinguished from each other, they may be simply referred to as a MIMO preprocessing circuit 13.

The clock generation unit 11 generates a clock of 16 GHz. The clock generation unit 11 supplies a clock to the ADCs 121 to 124.

An x-polarization component (also referred to as x data) of the signal light transmitted via the first core is input to the ADC 121. The x data is an analog signal. The ADC 121 samples the x data of the first core at the edge of the clock, converts the sampled x data into a digital value (also referred to as a sample), and outputs the digital value to the MIMO preprocessing circuit 131.

A y-polarization component (also referred to as y data) of the signal light transmitted via the first core is input to the ADC 122. The y data is an analog signal. The ADC 122 samples the y data of the first core at the edge of the clock, converts the sampled y data into a digital value, and outputs the digital value to the MIMO preprocessing circuit 132. In a case where the x data and the y data are not distinguished from each other, they may be simply referred to as data.

The x data of the second core is input to the ADC 123. The ADC 123 samples the x data of the second core at the edge of the clock, converts the sampled x data into a digital value, and outputs the digital value to the MIMO preprocessing circuit 133.

The y data of the second core is input to the ADC 124. The ADC 124 samples the y data of the second core at the edge of the clock, converts the sampled y data into a digital value, and outputs the digital value to the MIMO preprocessing circuit 134.

The MIMO preprocessing circuit 13 performs preprocessing of MIMO processing on the digital value output from the relevant ADC 12. The preprocessing includes average value calculation processing of calculating an average value of the digital values. The MIMO preprocessing circuit 13 outputs the preprocessed data to the MIMO circuit 14. The MIMO circuit 14 performs MIMO processing using the preprocessed data.

A sampling rate of each of the ADCs 121 to 124 is 16 Gsps (samples per second). Each of the MIMO preprocessing circuits 131 to 134 outputs a preprocessed sample. The output of each of the MIMO preprocessing circuits 131 to 134 is also 16 Gsps.

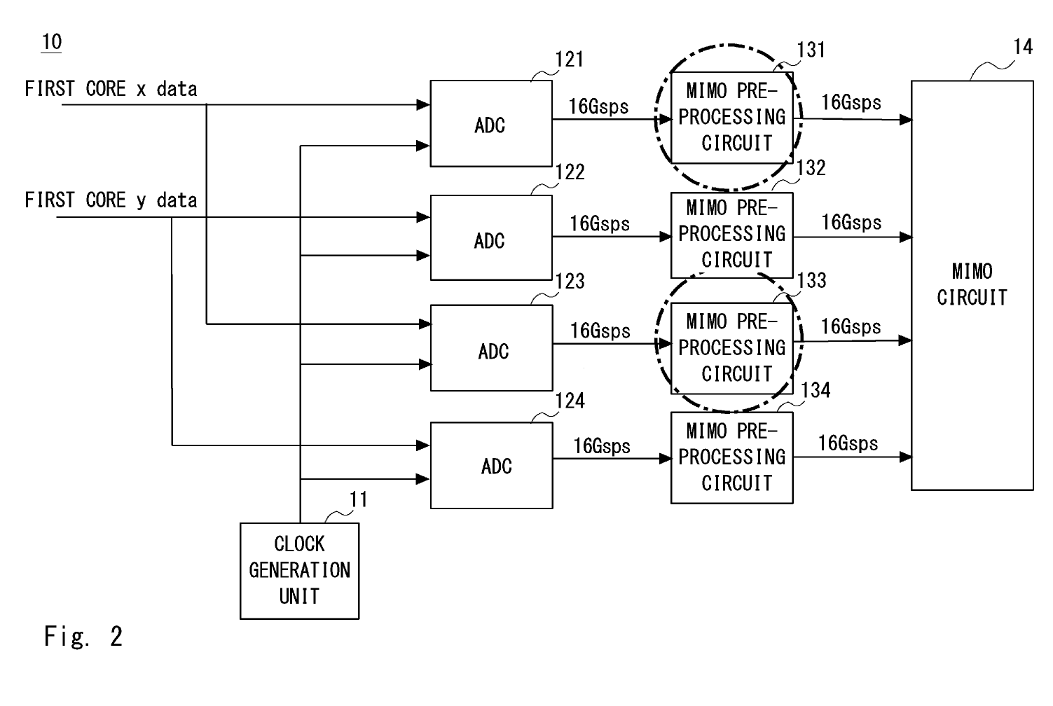

FIG. 2 is a diagram for explaining an example of processing for data transmitted via a single core fiber (SCF). The SCF includes a first core. Description overlapping with the description of FIG. 1 will be omitted.

The x data of the first core is input to the ADC 121. The ADC 121 samples the x data of the first core at the edge of the clock, converts the sampled x data into a digital value, and outputs the digital value to the MIMO preprocessing circuit 131.

The y data of the first core is input to the ADC 122. The ADC 122 samples the y data of the first core at the edge of the clock, converts the sampled x data into a digital value, and outputs the digital value to the MIMO preprocessing circuit 132.

The x data of the first core is input to the ADC 123. The ADC 123 samples the x data of the first core at the edge of the clock, converts the sampled x data into a digital value, and outputs the digital value to the MIMO preprocessing circuit 133.

The y data of the first core is input to the ADC 124. The ADC 124 samples the y data of the first core at the edge of the clock, converts the sampled y data into a digital value, and outputs the digital value to the MIMO preprocessing circuit 134.

The ADCs 121 and 123 perform AD conversion on the same data. The MIMO preprocessing circuits 131 and 133 perform MIMO preprocessing on the same data. Therefore, the results of the MIMO preprocessing output from the MIMO preprocessing circuits 131 and 133 are the same. Similarly, the results of the MIMO preprocessing output from the MIMO preprocessing circuits 132 and 134 are the same. Therefore, the outputs of the MIMO preprocessing circuits 131 and 133 are 16 Gsps, and the outputs of the MIMO preprocessing circuits 132 and 134 are also 16 Gsps. That is, the outputs of MIMO preprocessing circuits 131 to 134 decrease from 64 Gsps to 32 Gsps.

As described above, the related signal processing device 10 has a problem that the throughput decreases in a case where the MIMO processing is performed on the data transmitted via the SCF. The present inventor has arrived at the signal processing device according to the present disclosure from the problem of the signal processing device 10.

Hereinafter, a specific configuration of the present example embodiment will be described with reference to the drawings. The following description illustrates example embodiments of the present disclosure, and the scope of the present disclosure is not limited to the following example embodiments. In the following description, the same reference numerals indicate substantially the same contents.

### First example embodiment

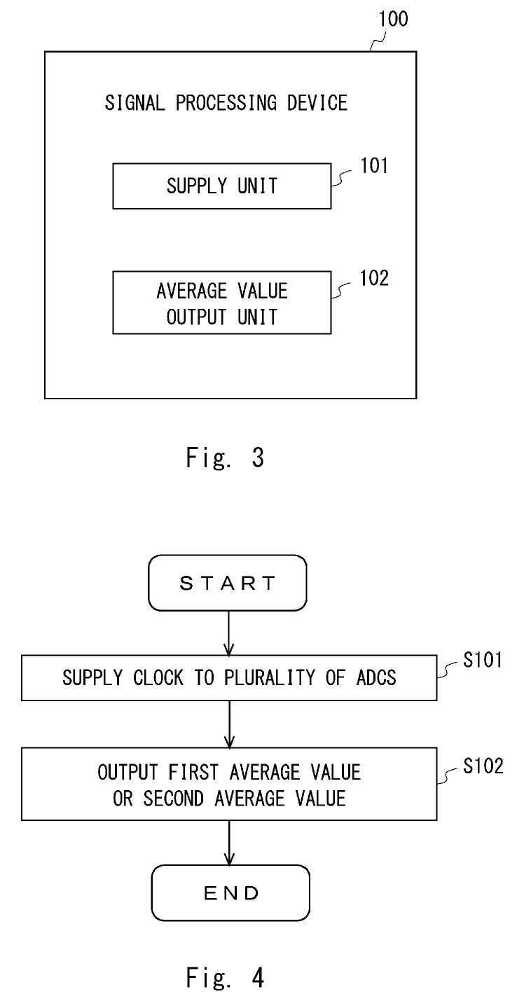

FIG. 3 is a block diagram illustrating a configuration example of a signal processing device 100 according to the present disclosure. The signal processing device 100 may be a computer that operates by a processor executing a program stored in a memory, or may be an electronic circuit.

The signal processing device 100 includes a supply unit 101 and an average value output unit 102. The supply unit 101 and the average value output unit 102 may be software or modules, processing of which is executed by a processor executing a program stored in a memory. Alternatively, the supply unit 101 and the average value output unit 102 may be hardware such as an electronic circuit or a semiconductor chip.

In a case where the plurality of signals input to the plurality of ADCs are not the same, the supply unit 101 supplies the same clock to the plurality of ADCs. In a case where the plurality of signals are the same, the supply unit 101 supplies clocks that are not the same to the plurality of ADCs. The supply unit 101 may be a selector circuit that selects a clock to be supplied to the ADC. Alternatively, the supply unit 101 may be a control unit that transmits a control signal for adjusting the phase of the clock.

In a case where the plurality of signals are not identical to each other, average value output unit 102 outputs, as the first average value, an average value of the plurality of digital values output from one ADC that is each of the plurality of ADCs. In a case where the plurality of signals are identical to each other, average value output unit 102 outputs the average value of the first average values in the plurality of ADCs as the second average value. The average value output unit 102 may be a selector circuit or an arithmetic unit that calculates the first average value and the second average value.

FIG. 4 is a flowchart illustrating a signal processing method according to the present disclosure. First, the supply unit 101 supplies a clock to the plurality of ADCs based on whether the signals input to the plurality of ADCs are the same (step S101). Next, the average value output unit 102 outputs the first average value or the second average value based on whether the signals input to the plurality of ADCs are identical to each other (step S102).

As described above, in a case where the same signals are input to the ADC, the signal processing device 100 supplies clocks that are not the same to the ADC, and calculates the second average value. As a result, since one average value can be calculated while the plurality of ADCs processes data that are not the same, the signal processing device 100 can suppress a decrease in throughput.

### Second example embodiment

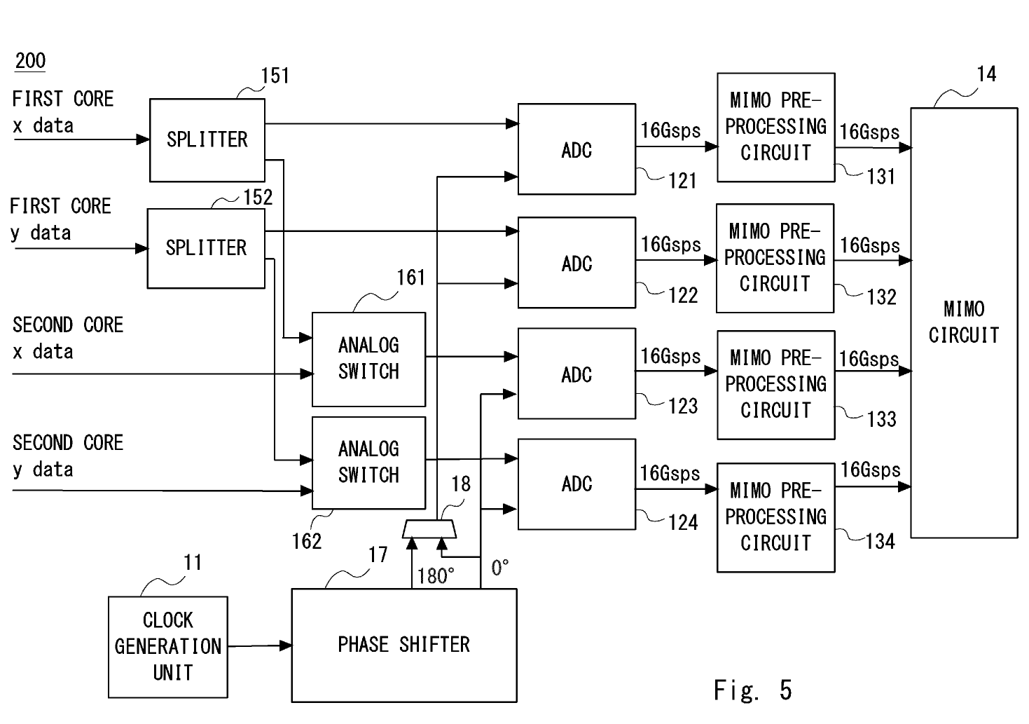

The second example embodiment is a specific example of the first example embodiment. FIG. 5 is a block diagram illustrating a configuration of a signal processing device 200 according to the present disclosure. Comparing FIG. 1 and FIG. 5, the signal processing device 200 further includes splitters 151 and 152, analog switches 161 and 162, a phase shifter 17, and a selector 18. If the splitters 151 and 152 are not distinguished from one another, they may be referred to simply as a splitter 15. In a case where the analog switches 161 and 162 are not distinguished from each other, they may be simply referred to as an analog switch 16. The selector 18 is relevant to the supply unit 101 described above.

Each component of the signal processing device 200 may be a software component or a module whose processing is carried out by causing the processor to execute the program stored in the memory. Alternatively, each component of the signal processing device 200 may be hardware such as a circuit or a semiconductor chip.

The x data and the y data of the first core shown in FIG. 5 may be data of the first core of the SCF, or may be data of the first core of the MCF. The x data and the y data of the second core are data of the second core of the MCF. In a case where data is transmitted through the SCF, the x data and the y data of the second core do not need to be input to the analog switch 16.

The x data of the first core is input to the splitter 151. The y data of the first core is input to the splitter 152. The x data of the second core is input to the analog switch 161. The y data of the second core is input to the analog switch 162.

The splitter 151 splits the x data of the first core into two pieces of data. One of the two pieces of data is input to the ADC 121. The other of the two pieces of data is input to the analog switch 161.

The splitter 152 splits the y data of the first core into two pieces of data. One of the two pieces of data is input to the ADC 122. The other of the two pieces of data is input to the analog switch 162.

In a case where data is transmitted via the SCF, the analog switch 161 outputs the x data of the first core of the SCF to the ADC 123. In a case where data is transmitted via the MCF, the analog switch 161 outputs the x data of the second core of the MCF to the ADC 123.

In a case where data is transmitted via the SCF, the analog switch 162 outputs the y data of the first core of the SCF to the ADC 124. In a case where data is transmitted via the MCF, the analog switch 162 outputs y data of the second core of the MCF to the ADC 124.

The phase shifter 17 adjusts the phase of the clock generated by the clock generation unit 11. The phase shifter is also referred to as a phase shift unit. The phase shifter 17 outputs a first clock and a second clock. The first clock is a clock in which the phase of the clock generated by the clock generation unit 11 is changed by 0°. That is, the first clock is a clock generated by the clock generation unit 11. The second clock is a clock in which the phase of the clock generated by clock generation unit 11 is changed by 180°.

The phase shifter 17 outputs the first clock to the ADC 123, the ADC 124, and the selector 18. The phase shifter 17 outputs the second clock to the selector 18.

The selector 18 selects one of the first clock and the second clock and supplies the selected clock to the ADCs 121 and 122. In a case where data is transmitted via the SCF, the selector 18 selects the second clock. In a case where data is transmitted via the MCF, the selector 18 selects the first clock.

Therefore, the timing at which the ADC 123 samples the x data of the first core of the SCF is not the same as the timing at which the ADC 121 samples the x data of the first core of the SCF. The timing at which the ADC 124 samples the y data of the first core of the SCF is not the same as the timing at which the ADC 122 samples the y data of the first core of the SCF. Therefore, the value sampled by the ADC 121 is not the same as the value sampled by the ADC 123. The value sampled by the ADC 122 is not the same as the value sampled by the ADC 124. The signal processing device 200 can also achieve a throughput of (16+16) Gsps × 2 = 64 Gsps for data transmitted via one core.

The signal processing device 200 may include a control unit (not illustrated) that transmits a selection signal to the selector 18. The control unit may further transmit the selection signal to selectors 1313, 1333, and 28 to be described later. The control unit may transmit a control signal to the analog switches 161 and 162.

The signal processing device 200 may include a reception unit (not illustrated) that receives the x data and the y data via the MCF or the SCF. The reception unit may separate the signal light transmitted via the MCF or the SCF into an x-polarization component and a y-polarization component, and perform coherent detection for detecting a signal (examples: x data, y data) by causing each polarization component and local light to interfere with each other.

Data transmitted via one channel of an optical fiber other than the SCF may be input to the splitter 151 or 152. One channel may be relevant to one core of the SCF.

Data transmitted via a first channel of the optical fiber other than the MCF may be input to the splitter 151, and data transmitted via a second channel of the optical fiber other than the MCF may be input to the analog switch 161. Data transmitted via a first channel of the optical fiber other than the MCF may be input to the splitter 152, and data transmitted via a second channel of the optical fiber other than the MCF may be input to the analog switch 162. A plurality of channels including the first channel and the second channel may be relevant to a plurality of cores of the MCF.

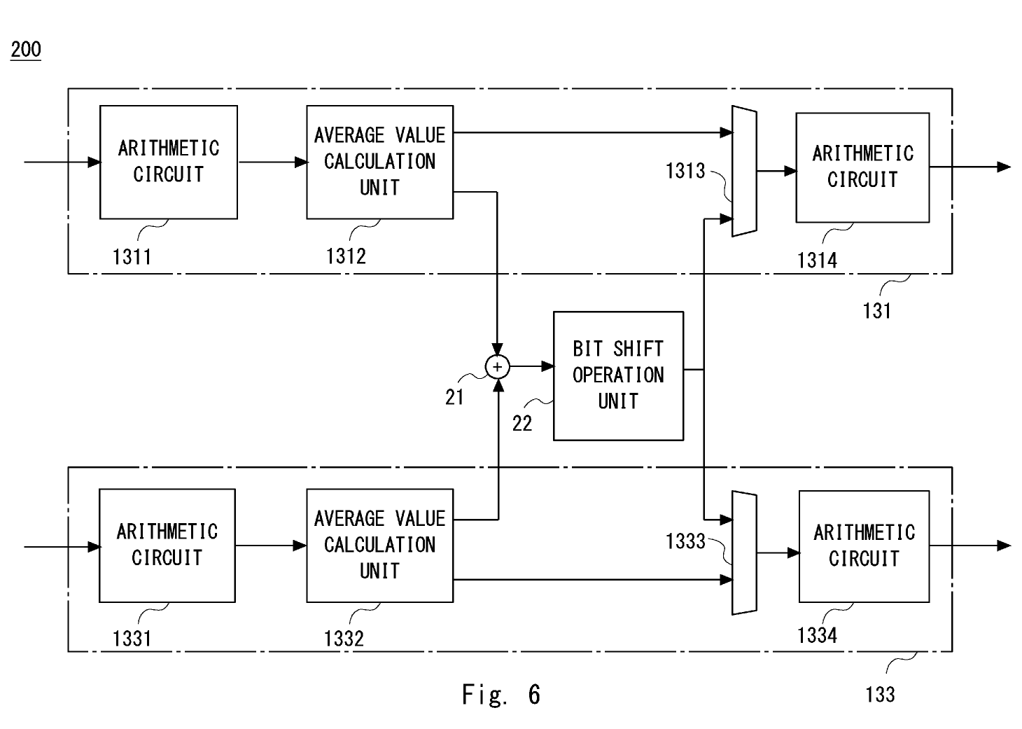

FIG. 6 is a diagram for explaining operations of the MIMO preprocessing circuits 131 and 133. The MIMO preprocessing circuit 131 includes an arithmetic circuit 1311, an average value calculation unit 1312, a selector 1313, and an arithmetic circuit 1314. The MIMO preprocessing circuit 133 includes an arithmetic circuit 1331, an average value calculation unit 1332, a selector 1333, and an arithmetic circuit 1334. The selectors 1313 and 1333 are relevant to the average value output unit 102 described above.

The signal processing device 200 includes an addition unit 21 and a bit shift operation unit 22.

The average value calculation unit 1312 calculates an average value (also referred to as a first average value) of data acquired from the ADC 121 via the arithmetic circuit 1311. The arithmetic circuit 1311 may perform, for example, processing of removing noise of data output from the ADC 121.

The average value calculation unit 1332 calculates an average value (also referred to as a first average value) of data acquired from the ADC 123 via the arithmetic circuit 1331. The arithmetic circuit 1331 may perform, for example, processing of removing noise of data output from the ADC 123.

The addition unit 21 calculates the sum of the average value calculated by the average value calculation unit 1312 and the average value calculated by the average value calculation unit 1332. The bit shift operation unit 22 performs an operation for dividing the sum calculated by the addition unit 21 by the number of ADCs to which the same data is input (example: 2). For example, the bit shift operation unit 22 shifts the sum calculated by the addition unit 21 to the right by 1 bit. The calculation result by the bit shift operation unit 22 represents an average value (also referred to as a second average value) of the average value calculated by the average value calculation unit 1312 and the average value calculated by the average value calculation unit 1332. The second average value is an average value of data including data sampled by the ADC 121 and data sampled by the ADC 123.

The selector 1313 selects one of the first average value calculated by the average value calculation unit 1312 and the second average value calculated by the bit shift operation unit 22, and outputs the selected average value to the arithmetic circuit 1314. In a case where data is transmitted via the MCF, the selector 1313 selects the first average value. In a case where data is transmitted via the SCF, the selector 1313 selects the second average value. The arithmetic circuit 1314 performs an arithmetic operation using the average value.

The selector 1333 selects one of the first average value calculated by the average value calculation unit 1332 and the second average value calculated by the bit shift operation unit 22, and outputs the selected average value to the arithmetic circuit 1334. In a case where data is transmitted via the MCF, the selector 1333 selects the first average value. In a case where data is transmitted via the SCF, the selector 1333 selects the second average value. The arithmetic circuit 1334 performs an arithmetic operation using the average value.

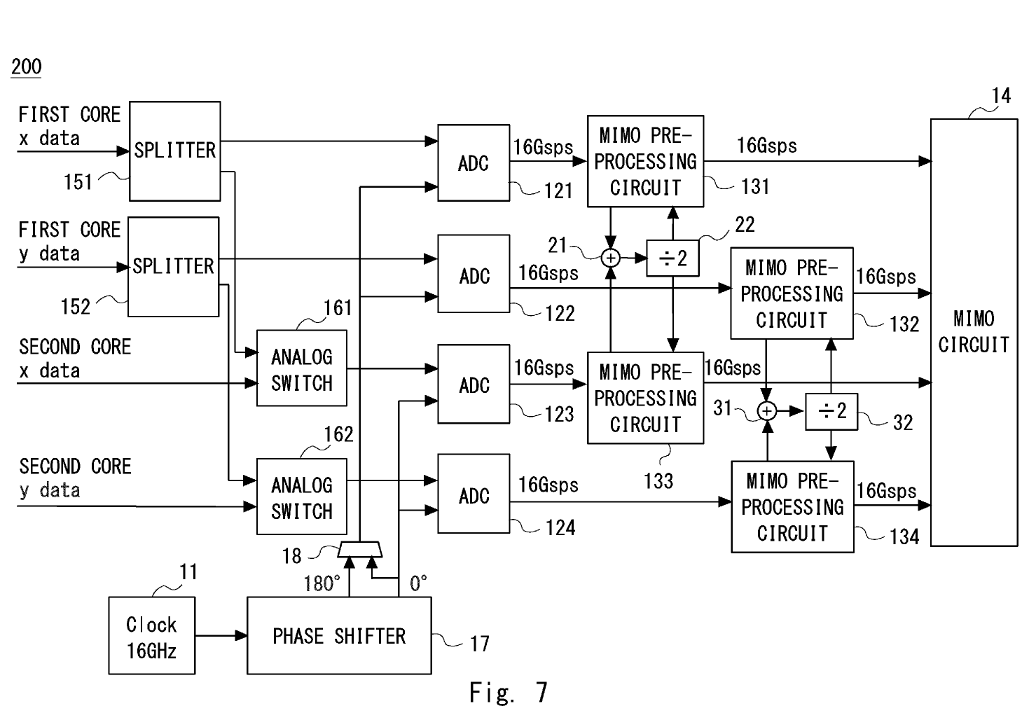

The operations of the MIMO preprocessing circuits 132 and 134 are similar to those of the MIMO preprocessing circuits 131 and 133. FIG. 7 is a block diagram illustrating a configuration of a signal processing device 200 according to the present disclosure. Comparing FIG. 5 with FIG. 7, FIG. 7 additionally includes an addition unit 21 and a bit shift operation unit 22. An addition unit 31 and a bit shift operation unit 32 are added. The addition unit 31 calculates the sum of the average value calculated by the MIMO preprocessing circuit 132 and the average value calculated by the MIMO preprocessing circuit 134. The bit shift operation unit 32 performs an operation for dividing the sum calculated by the addition unit 31 by the number of ADCs to which the same data is input (example: 2).

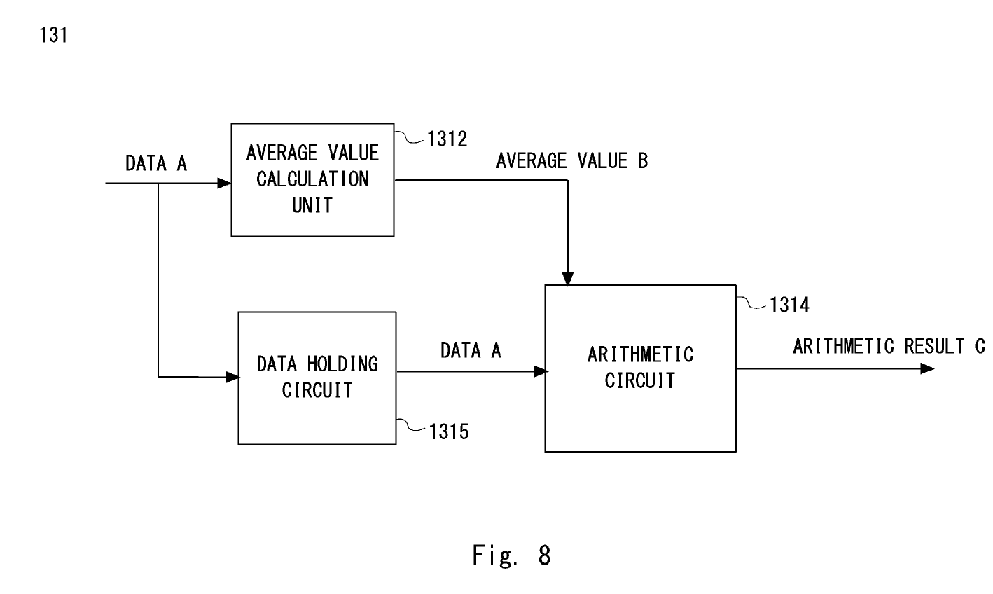

In the MIMO preprocessing, for example, direct current (DC) offset processing, normalization processing, distortion compensation processing, and wavelength dispersion compensation are executed. FIG. 8 is a diagram for explaining DC offset processing in a case where data is transmitted via the MCF. The MIMO preprocessing circuit 131 may perform processing (example: normalization processing) that is not the same as the DC offset processing by using the average value.

The MIMO preprocessing circuit 131 includes an average value calculation unit 1312, a data holding circuit 1315, and an arithmetic circuit 1314. Assuming that A is data acquired by the MIMO preprocessing circuit 131, the data holding circuit 1315 holds the data A. The data A may include a plurality of digital values. The average value calculation unit 1312 calculates an average value B that is an average value of the data A. The arithmetic circuit 1314 subtracts the average value B from the data A and outputs a subtraction result as an arithmetic result C. The MIMO preprocessing circuit 133 also operates similarly to the MIMO preprocessing circuit 131.

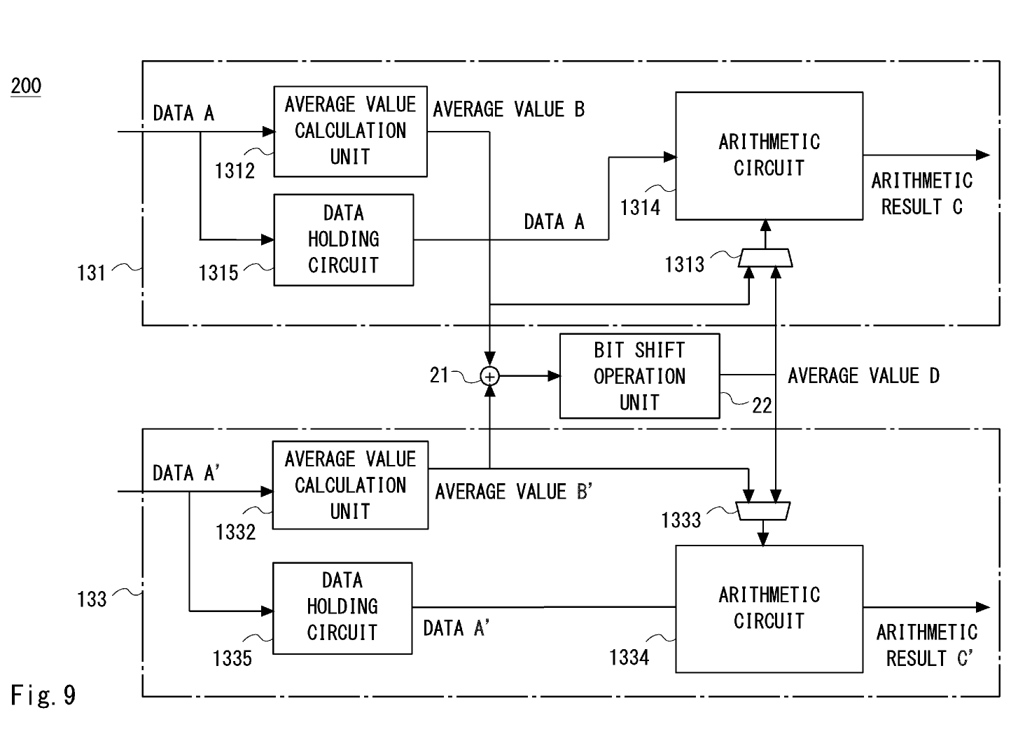

FIG. 9 is a diagram for explaining DC offset processing in a case where data is transmitted via the SCF. The MIMO preprocessing circuit 133 includes an average value calculation unit 1332, a data holding circuit 1335, and an arithmetic circuit 1334. Assuming that the data acquired by the MIMO preprocessing circuit 133 is A’, the data holding circuit 1335 holds the data A’. The average value calculation unit 1332 calculates an average value B’ which is an average value of the data A’.

The addition unit 21 and the bit shift operation unit 22 calculate an average value D from the average value B calculated by the average value calculation unit 1312 and the average value B’ calculated by the average value calculation unit 1332.

The arithmetic circuit 1314 of the MIMO preprocessing circuit 131 subtracts the average value D selected by the selector 1313 from the data A held by the data holding circuit 1315, and outputs a subtraction result as the arithmetic result C. The arithmetic circuit 1334 of the MIMO preprocessing circuit 133 subtracts the average value D selected by the selector 1333 from the data A’ held by the data holding circuit 1335, and outputs a subtraction result as the arithmetic result C’. The arithmetic circuits 1314 and 1334 are also referred to as offset adjustment units.

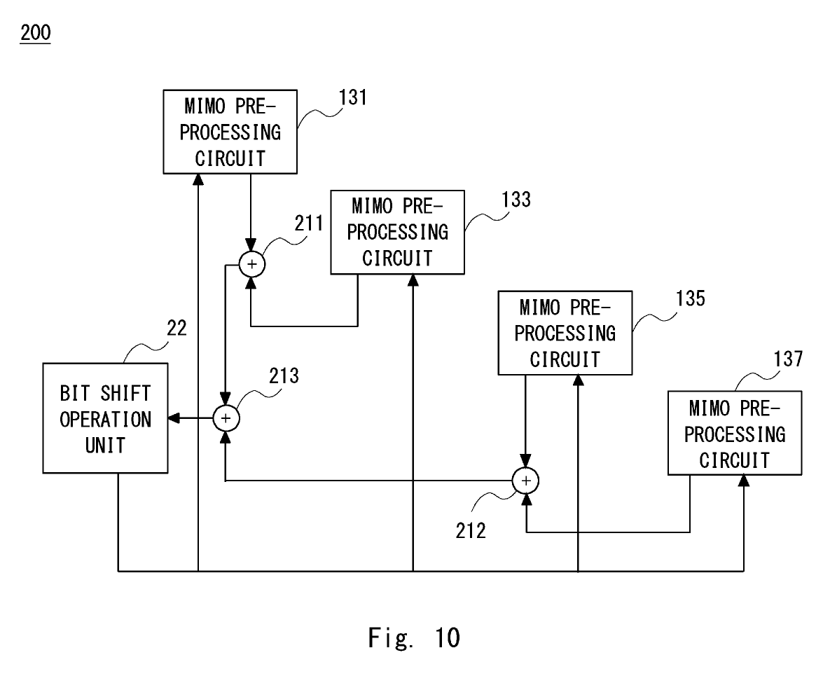

The number of ADCs 12 to which the same data is input, for example, the number of cores of the MCF may be 3 or more (examples: 4, 12). FIG. 10 is a diagram for explaining processing of calculating the second average value in a case where the number of ADCs 12 to which the same data is input is 4. The signal processing device 200 illustrated in FIG. 10 includes a MIMO preprocessing circuit 131, a MIMO preprocessing circuit 133, a MIMO preprocessing circuit 135, a MIMO preprocessing circuit 137, an addition unit 211, an addition unit 212, an addition unit 213, and a bit shift operation unit 22.

The addition unit 211 calculates a sum of the first average value calculated by the MIMO preprocessing circuit 131 and the first average value calculated by the MIMO preprocessing circuit 133. The addition unit 212 calculates a sum of the first average value calculated by the MIMO preprocessing circuit 135 and the first average value calculated by the MIMO preprocessing circuit 137. The addition unit 213 adds the sum calculated by the addition unit 211 and the sum calculated by the addition unit 212 to calculate the sum of the first average values calculated by the MIMO preprocessing circuits 131, 133, 135, and 137. The bit shift operation unit 22 calculates the second average value by shifting the sum of the first average values calculated by the addition unit 213 rightward by 2 bits.

Referring again to FIG. 9, the number of samples (example: 100) input as the data A or A’ in a case where data is transmitted via the SCF may be half the number of samples (example: 200) input as the data A or A’ in a case where data is transmitted via the MCF. In a case where data is transmitted via the SCF, the amount of data processed per cycle by the average value calculation unit 1312 is, for example, 2 pieces of data/cycle. In a case where data is transmitted via the MCF, the amount of data processed per cycle by the average value calculation unit 1312 is, for example, 4 pieces of data/cycle. The average value calculation unit 1312 may be configured to be able to calculate an average value of data of amounts that are not the same as each other.

In general, in a case where the signals input to the ADCs 121 and 123 are not the same, m digital values may be input to the average value calculation unit 1312 per cycle. In a case where the signals input to the ADCs 121 and 123 are the same, n digital values may be input to the average value calculation unit 1312 per cycle. m and n are integers of 2 or more, and m is an integral multiple of n. m/n is relevant to the number of the ADC 12 to which the same signal is input.

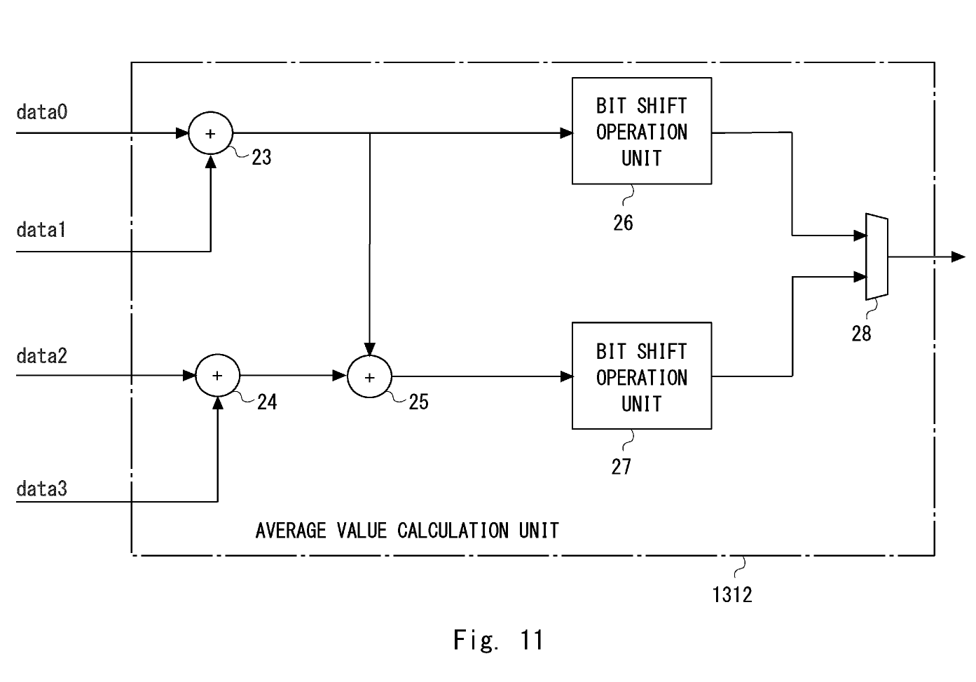

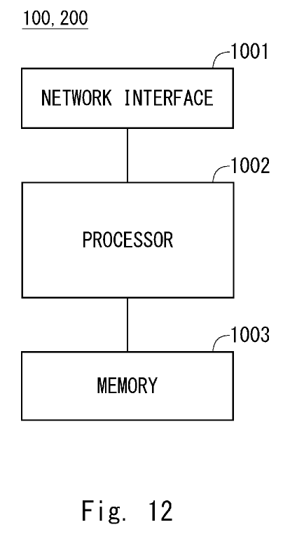

FIG. 11 is a block diagram illustrating a configuration of the average value calculation unit 1312. The average value calculation unit 1312 includes addition units 23, 24, and 25, bit shift operation units 26 and 27, and a selector 28. The selector 28 is also referred to as a selection unit.

In a case where data is transmitted via the SCF, the ADC 121 outputs data 0 and 1 to the average value calculation unit 1312. In a case where data is transmitted via the MCF, the ADC 121 outputs data 0 to 3 to the average value calculation unit 1312. The addition unit 23 calculates the sum of the data 0 and 1. The addition unit 24 calculates the sum of the data 2 and 3. The addition unit 25 adds the sum calculated by the addition unit 23 and the sum calculated by the addition unit 24 to calculate the sum of the data 0 to 3. The bit shift operation unit 26 shifts the sum of data 0 and 1 calculated by the addition unit 25 to the right by 1 bit. That is, the bit shift operation unit 26 calculates an average value obtained by dividing the sum total of the data 0 and 1 by 2. The bit shift operation unit 27 shifts the sum of data 0 to 3 calculated by the addition unit 25 to the right by 2 bits. That is, the bit shift operation unit 27 calculates an average value obtained by dividing the sum total of the data 0 to 3 by 4. The selector 28 selects the average value calculated by the bit shift operation unit 26 or the average value calculated by the bit shift operation unit 27, and outputs the selected average value. In a case where data is transmitted via the SCF, the selector 28 selects the average value calculated by the bit shift operation unit 26. In a case where data is transmitted via the MCF, the selector 28 selects the average value calculated by the bit shift operation unit 27.

In the second example embodiment, the data transfer rate (baud rate) of the MIMO preprocessing circuit in a case where data is transmitted via two cores and the data transfer rate of the MIMO preprocessing circuit in a case where data is transmitted via one core can be the same. In the second example embodiment, it is possible to calculate an average value of data transmitted via each of a plurality of types of optical fibers in which the number of cores is not the same. That is, it is not necessary to manufacture a signal processing device relevant to the number of cores of the optical fiber, and the manufacturing cost of the signal processing device can be reduced.

FIG. 12 is a block diagram illustrating an example of a hardware configuration of the signal processing devices 100 and 200 (hereinafter, referred to as a signal processing device 100 or the like). Referring to FIG. 12, the signal processing device 100 or the like includes a network interface 1001, a processor 1002, and a memory 1003. The network interface 1001 is used to communicate with other network node apparatuses that constitute a communication system.

The processor 1002 reads and executes software (computer program) from the memory 1003 to perform the processing in Step S101 and S102 in FIG. 4. The processor 1002 may be, for example, a microprocessor, an MPU, or a CPU. The processor 1002 may include a plurality of processors.

The memory 1003 is constituted by a combination of a volatile memory and a nonvolatile memory. The memory 1003 may include a storage disposed away from the processor 1002. In this case, the processor 1002 may access the memory 1003 via an input/output (I/O) interface, which is not illustrated.

In the example in FIG. 12, the memory 1003 is used to store software modules. The processor 1002 can perform the processing in steps S101 and S102 by reading and executing the software modules from the memory 1003.

As described with reference to FIG. 12, each of the processors included in the signal processing device 100 and the like in the above-described example embodiments executes one or more programs including commands for causing a computer to perform the algorithms described with reference to the drawings.

In the example described above, the program includes commands (or software codes) for causing a computer to execute one or more functions described in the example embodiments in a case where the program is read by the computer. The program may be retained in a non-transitory computer-readable medium or a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, and a magnetic cassette, a magnetic tape, a magnetic disk storage, or any other magnetic storage device. The program may be transmitted through a transitory computer-readable medium or a communication medium. As an example and not by way of limitation, the transitory computer-readable medium or the communication medium includes an electrical signal, an optical signal, an acoustic signal, or any other form of propagated signal.

The technical ideas of the present disclosure are not limited to the above example embodiment and can be appropriately modified without departing from the scope.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example to illustrate one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other figures, for example, to create an example embodiment that is not explicitly illustrated or described. All of the features or steps illustrated in any one of the figures to explain illustrative example embodiments are not necessarily mandatory, and some features or steps may be omitted. The order of the steps described in any of the figures may be changed as appropriate.

Some or all of the above-described example embodiments may be described as the following Supplementary Notes, but are not limited to the following Supplementary Notes.

Some or all of the elements (such as configurations and functions, for example) described in Supplementary Notes 2 to 8 depending on Supplementary Note 1 may depend from Supplementary Notes 9 to 10 as well with depending relationships similar to those of Supplementary Notes 2 to 8. Some or all of the elements described in any Supplementary Note may be applied to various types of hardware, software, recording means for recording software, systems, and methods.

### Supplementary Note 1

A signal processing device including: a supply unit that supplies identical clocks to a plurality of analog-to-digital converters (ADCs) in a case where a plurality of signals input to the plurality of ADCs are not identical to each other, and supplies non-identical clocks to the plurality of ADCs in a case where the plurality of signals are identical to each other; and an average value output unit that outputs an average value of a plurality of digital values output from one ADC that is each of a plurality of the ADCs as a first average value in a case where the plurality of signals are not identical to each other, and outputs an average value of the first average values in the plurality of the ADCs as a second average value in a case where the plurality of signals are identical to each other.

### Supplementary Note 2

The signal processing device according to Supplementary Note 1, in which the signal processing device includes an addition unit that calculates a sum of the first average values of the plurality of ADCs, and a bit shift operation unit that divides the sum by a number of the plurality of ADCs.

### Supplementary Note 3

The signal processing device according to Supplementary Note 1 or 2, in which the plurality of ADCs includes a first ADC and a second ADC, the supply unit supplies a first clock to the first ADC, the signal processing device includes a phase shift unit that outputs a second clock having a phase different from a phase of the first clock by 180°, and the supply unit supplies the first clock to the second ADC in a case where the plurality of signals are not identical to each other, and supplies the second clock to the second ADC in a case where the plurality of signals are identical to each other.

### Supplementary Note 4

The signal processing device according to Supplementary Note 3, in which each of the plurality of signals that are not identical to each other is transmitted via a plurality of channels of a first optical fiber, and the plurality of signals identical to each other is obtained by splitting a signal transmitted via one channel of a second optical fiber.

### Supplementary Note 5

The signal processing device according to Supplementary Note 4, in which each of the plurality of channels of the first optical fiber is relevant to a plurality of cores of a multi core fiber (MCF), and the one channel of the second optical fiber is relevant to one core of a single core fiber (SCF).

### Supplementary Note 6

The signal processing device according to Supplementary Note 5, including: a splitter; and an analog switch, in which the splitter splits a signal transmitted via a first core of the MCF or a first core of the SCF, one of the signals split by the splitter is input to the first ADC, and the analog switch outputs another one of the signals split by the splitter to the second ADC in a case where the splitter splits the signal transmitted via the first core of the SCF, and outputs a signal transmitted via a second core of the MCF to the second ADC in a case where the splitter splits the signal transmitted via the first core of the MCF.

### Supplementary Note 7

The signal processing device according to Supplementary Note 2, including an average value calculation unit that calculates the first average value, in which in a case where the plurality of signals are not identical to each other, m (m is an integer of 2 or more) digital values are input to the average value calculation unit per cycle, and in a case where the plurality of signals are identical to each other, n (n is an integer of 2 or more) digital values are input to the average value calculation unit per cycle, m is an integer multiple of n, m/n is relevant to a number of the ADCs, and the average value calculation unit includes a selection unit that selects either an average value of the m digital values or an average value of the n digital values as the first average value.

### Supplementary Note 8

The signal processing device according to Supplementary Note 1 or 2, including an offset adjustment unit that subtracts the first average value or the second average value from each of the plurality of digital values output from one of the ADCs.

### Supplementary Note 9

A signal processing method including: supplying identical clocks to a plurality of analog-to-digital converters (ADCs) in a case where a plurality of signals input to the plurality of ADCs are not identical to each other, and supplying non-identical clocks to the plurality of ADCs in a case where the plurality of signals are identical to each other; and outputting an average value of a plurality of digital values output from one ADC that is each of a plurality of the ADCs as a first average value in a case where the plurality of signals are not identical to each other, and outputting an average value of the first average values in the plurality of the ADCs as a second average value in a case where the plurality of signals are identical to each other.

### Supplementary Note 10

A program for causing a computer to execute: a process of supplying identical clocks to a plurality of analog-to-digital converters (ADCs) in a case where a plurality of signals input to the plurality of ADCs are not identical to each other, and supplying non-identical clocks to the plurality of ADCs in a case where the plurality of signals are identical to each other; and a process of outputting an average value of a plurality of digital values output from one ADC that is each of a plurality of the ADCs as a first average value in a case where the plurality of signals are not identical to each other, and outputting an average value of the first average values in the plurality of the ADCs as a second average value in a case where the plurality of signals are identical to each other.

1. A signal processing device comprising:
a supply circuit that supplies identical clocks to a plurality of analog-to-digital converters (ADCs) in a case where a plurality of signals input to the plurality of ADCs are not identical to each other, and supplies non-identical clocks to the plurality of ADCs in a case where the plurality of signals are identical to each other; and
an average value output circuit that outputs an average value of a plurality of digital values output from one ADC that is each of a plurality of the ADCs as a first average value in a case where the plurality of signals are not identical to each other, and outputs an average value of the first average values in the plurality of the ADCs as a second average value in a case where the plurality of signals are identical to each other.

2. The signal processing device according to claim 1, wherein the signal processing device includes an addition circuit that calculates a sum of the first average values of the plurality of ADCs, and a bit shift operation circuit that divides the sum by a number of the plurality of ADCs.

3. The signal processing device according to claim 1, wherein
the plurality of ADCs includes a first ADC and a second ADC,
the supply circuit supplies a first clock to the first ADC,
the signal processing device includes a phase shift circuit that outputs a second clock having a phase different from a phase of the first clock by 180°, and
the supply circuit supplies the first clock to the second ADC in a case where the plurality of signals are not identical to each other, and supplies the second clock to the second ADC in a case where the plurality of signals are identical to each other.

4. The signal processing device according to claim 3, wherein
each of the plurality of signals that are not identical to each other is transmitted via a plurality of channels of a first optical fiber, and
the plurality of signals identical to each other is obtained by splitting a signal transmitted via one channel of a second optical fiber.

5. The signal processing device according to claim 4, wherein
each of the plurality of channels of the first optical fiber is relevant to a plurality of cores of a multi core fiber (MCF), and
the one channel of the second optical fiber is relevant to one core of a single core fiber (SCF).

6. The signal processing device according to claim 5, comprising:
a splitter; and
an analog switch, wherein
the splitter splits a signal transmitted via a first core of the MCF or a first core of the SCF,
one of the signals split by the splitter is input to the first ADC, and
the analog switch outputs another one of the signals split by the splitter to the second ADC in a case where the splitter splits the signal transmitted via the first core of the SCF, and outputs a signal transmitted via a second core of the MCF to the second ADC in a case where the splitter splits the signal transmitted via the first core of the MCF.

7. The signal processing device according to claim 2, comprising an average value calculation circuit that calculates the first average value, wherein
in a case where the plurality of signals are not identical to each other, m (m is an integer of 2 or more) digital values are input to the average value calculation circuit per cycle, and in a case where the plurality of signals are identical to each other, n (n is an integer of 2 or more) digital values are input to the average value calculation circuit per cycle,
m is an integer multiple of n,
m/n is relevant to a number of the ADCs, and
the average value calculation circuit includes a selection circuit that selects either an average value of the m digital values or an average value of the n digital values as the first average value.

8. The signal processing device according to claim 1, comprising an offset adjustment circuit that subtracts the first average value or the second average value from each of the plurality of digital values output from one of the ADCs.

9. A signal processing method comprising:
supplying identical clocks to a plurality of analog-to-digital converters (ADCs) in a case where a plurality of signals input to the plurality of ADCs are not identical to each other, and supplying non-identical clocks to the plurality of ADCs in a case where the plurality of signals are identical to each other; and
outputting an average value of a plurality of digital values output from one ADC that is each of a plurality of the ADCs as a first average value in a case where the plurality of signals are not identical to each other, and outputting an average value of the first average values in the plurality of the ADCs as a second average value in a case where the plurality of signals are identical to each other.

10. A non-transitory computer-readable medium storing a program for causing a computer to execute:
a process of supplying identical clocks to a plurality of analog-to-digital converters (ADCs) in a case where a plurality of signals input to the plurality of ADCs are not identical to each other, and supplying non-identical clocks to the plurality of ADCs in a case where the plurality of signals are identical to each other; and
a process of outputting an average value of a plurality of digital values output from one ADC that is each of a plurality of the ADCs as a first average value in a case where the plurality of signals are not identical to each other, and outputting an average value of the first average values in the plurality of the ADCs as a second average value in a case where the plurality of signals are identical to each other.
